(19) United States
(12) Patent Application Publication
(10) Pub. No.: US 2014/0158521 A1
(43) Pub. Date: Jun. 12, 2014

(54) METHODS AND APPARATUSES FOR SEPARATING DESORBENT FROM MULTIPLE STREAMS

(71) Applicant: UOP LLC, Des Plaines, IL (US)

(72) Inventors: David William Ablin, Arlington Heights, IL (US); Jason T. Corradi, Arlington Heights, IL (US)

(73) Assignee: UOP LLC, Des Plaines, IL (US)

(21) Appl. No.: 13/712,697

(22) Filed: Dec. 12, 2012

(51) Int. Cl. B01D 3/40

(52) U.S. Cl. CPC B01D 3/40
USPC 203/50; 202/158

(57) ABSTRACT

Methods and apparatuses for separating desorbent from an extract stream and a raffinate stream are provided. An exemplary method includes fractionating a first stream in a first fractionation zone into a first fractionation overhead stream and a first fractionation bottom stream. The first stream includes an extract stream including a desorbent from an adsorption zone. A second stream different from the first stream is fractionated in a second fractionation zone into a second fractionation overhead stream and a second fractionation bottom stream. The second fractionation zone is in liquid isolation from and in vapor communication with the first fractionation zone. The second stream includes a raffinate stream including the desorbent from the adsorption zone. The first and second fractionation bottom streams are separately removed from the respective fractionation zones. The first and second fractionation overhead streams are combined to produce a combined fractionation overhead stream that includes the desorbent.

### TECHNICAL FIELD

The technical field generally relates to methods and apparatuses for adsorption and desorption and more particularly relates to methods and apparatuses for separating a desorbent from different streams that include the desorbent.

### BACKGROUND

Adsorption/desorption is a common separation technique that is employed for separation of various molecules from a mixed stream that includes the molecules to be adsorbed along with other molecules. Adsorption/desorption is particularly useful to separate certain molecules from the mixed stream that may otherwise be difficult to separate through other separation techniques, such as fractionation. For example, adsorption/desorption is commonly used to separate isomers of certain hydrocarbon compounds, such as C5 to C8 hydrocarbons, whereas fractionation is not effective to separate the isomers. Adsorption/desorption is also commonly used to remove contaminants that are present at low concentrations from various feed streams.

Adsorption generally involves collection of molecules from the mixed stream on a surface of an adsorbent material that adsorbs the molecules selectively over other molecules in the mixed stream. A desorbent stream that can be readily separated from the adsorbed molecules, such as through fractionation, is employed to remove the adsorbed molecules from the adsorbent material. Portions of the mixed stream that are not adsorbed by the adsorbent material remain in a raffinate stream after adsorption.

Various adsorption/desorption techniques allow for continuous adsorption and desorption. For example, countercurrent flow of the mixed stream over a solid adsorbent material is one technique that is commonly employed to effectuate adsorption and desorption. In this technique, desorbents are used that are effective to desorb the adsorbed molecules from the solid adsorbent material, and the desorbent also dilutes the portions of the mixed stream that remain after adsorption of the molecules from the mixed stream. As a result, an extract stream and a raffinate stream are produced. The extract stream includes the adsorbed molecules and the desorbent, and the raffinate stream includes portions of the mixed stream that remain after adsorption of the molecules from the mixed stream along with the desorbent.

The desorbent is generally separated from the extract stream and the raffinate stream to recover the desorbent for further use. Due to different compositional makeup of the extract stream and the raffinate stream, the extract stream and the raffinate stream are generally fractionated through separate fractionation techniques to separate the individual compounds therefrom. Separate fractionation columns and associated units such as receiver vessels and overhead pumps are thus required for fractionating the extract stream and the raffinate stream. This duplication of hardware increases the cost of adsorption/desorption assemblies and decreases the efficiencies of such systems.

Accordingly, it is desirable to provide methods and apparatuses for separating desorbent from an extract stream and a raffinate stream that enable duplication of fractionation equipment to be minimized. Furthermore, other desirable features and characteristics of the present invention will become apparent from the subsequent detailed description of the invention and the appended claims, taken in conjunction with the accompanying drawings and this background of the invention.

### BRIEF SUMMARY

Methods and apparatuses for separating desorbent from an extract stream and a raffinate stream are provided. In an embodiment, a method of separating desorbent from an extract stream and a raffinate stream includes fractionating a first stream in a first fractionation zone into a first fractionation overhead stream and a first fractionation bottom stream. The first stream includes an extract stream from an adsorption zone, and the first fractionation overhead stream includes a desorbent. A second stream that is different from the first stream is fractionated in a second fractionation zone into a second fractionation overhead stream and a second fractionation bottom stream. The second fractionation zone is in liquid isolation from and in vapor communication with the first fractionation zone. The second stream includes a raffinate stream from the adsorption zone, and the second fractionation overhead stream includes the desorbent. The first fractionation bottom stream is removed from the first fractionation zone and the second fractionation bottom stream is removed from the second fractionation zone separate from the first fractionation bottom stream. The first fractionation overhead stream from the first fractionation zone and the second fractionation overhead stream from the second fractionation zone are combined to produce a combined fractionation overhead stream that includes the desorbent.

In another embodiment, a method of separating desorbent from multiple streams includes providing a split fractionation column that includes an internal partition. The internal partition defines a first fractionation zone and a second fractionation zone in liquid isolation from and in vapor communication with the first fractionation zone. A first stream is fractionated in the first fractionation zone into a first fractionation overhead stream and a first fractionation bottom stream. The first stream includes an extract stream from an adsorption zone, and the first fractionation overhead stream includes a desorbent. A second stream different from the first stream is fractionated in a second fractionation zone into a second fractionation overhead stream and a second fractionation bottom stream. The second fractionation zone is in liquid isolation from and in vapor communication with the first fractionation zone. The second stream includes a raffinate stream from the adsorption zone, and the second fractionation overhead stream includes the desorbent. The first fractionation bottom stream is removed from the first fractionation zone and the second fractionation bottom stream is removed from the second fractionation zone separate from the first fractionation bottom stream. The first fractionation overhead stream from the first fractionation zone and the second fractionation overhead stream from the second fractionation zone are combined to produce a combined fractionation overhead stream that includes the desorbent.

In another embodiment, an apparatus for separating desorbent from multiple streams includes an adsorption zone for receiving a feed stream and for selectively adsorbing a component from the feed stream to produce an extract stream and a raffinate stream. The apparatus further includes a split fractionation column that includes an internal partition. The internal partition defines a first fractionation zone and a second fractionation zone in liquid isolation from and in vapor communication with the first fractionation zone. The first fractionation zone is in fluid communication with the adsorption zone for receiving a first stream that includes the extract stream from the adsorption zone. The second fractionation zone is also in fluid communication with the adsorption zone for receiving the second stream that includes the raffinate stream from the adsorption zone.

### DETAILED DESCRIPTION OF THE DRAWINGS

The various embodiments will hereinafter be described in conjunction with the following drawing figures, wherein like numerals denote like elements, and wherein:

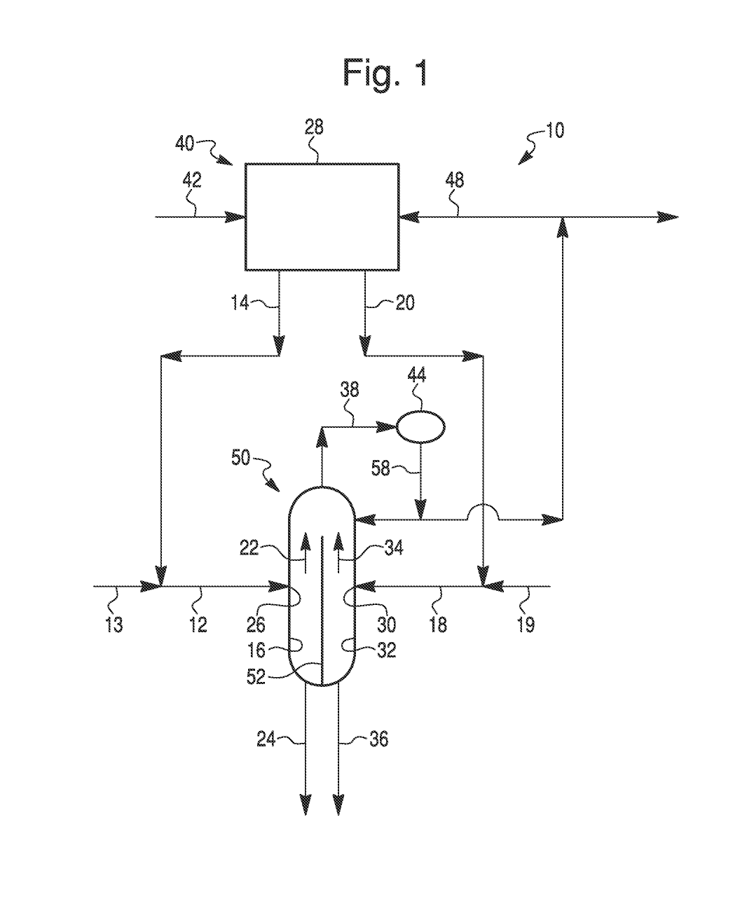

FIG. 1 is a schematic diagram of an apparatus and method for separating desorbent from an extract stream and a raffinate stream in accordance with an exemplary embodiment;

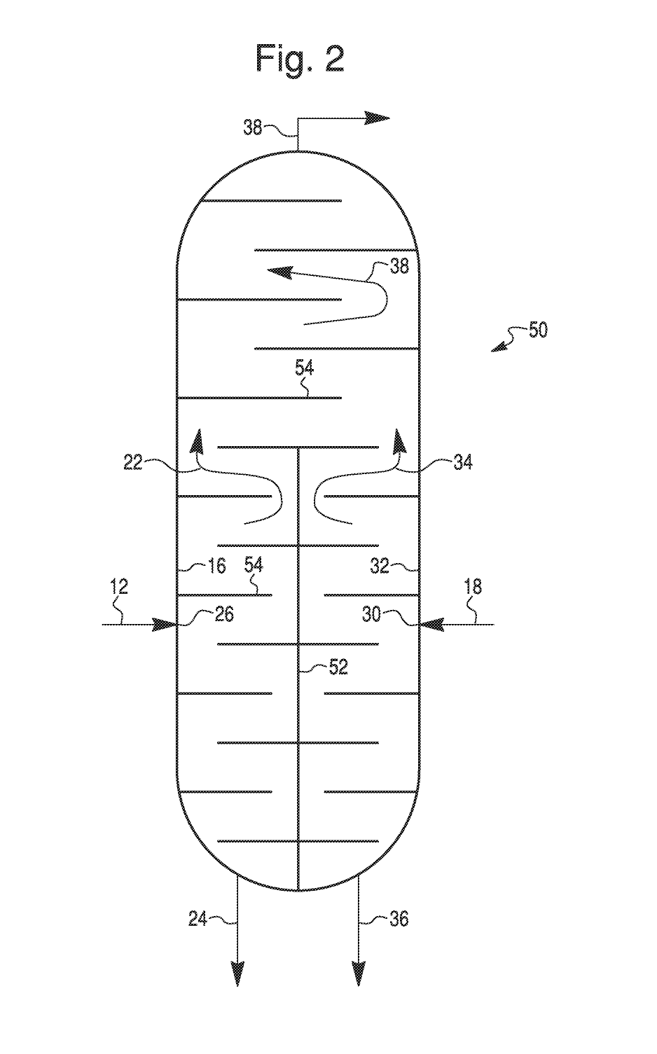

FIG. 2 is a schematic cross-sectional side view of a split fractionation column in accordance with an exemplary embodiment; and

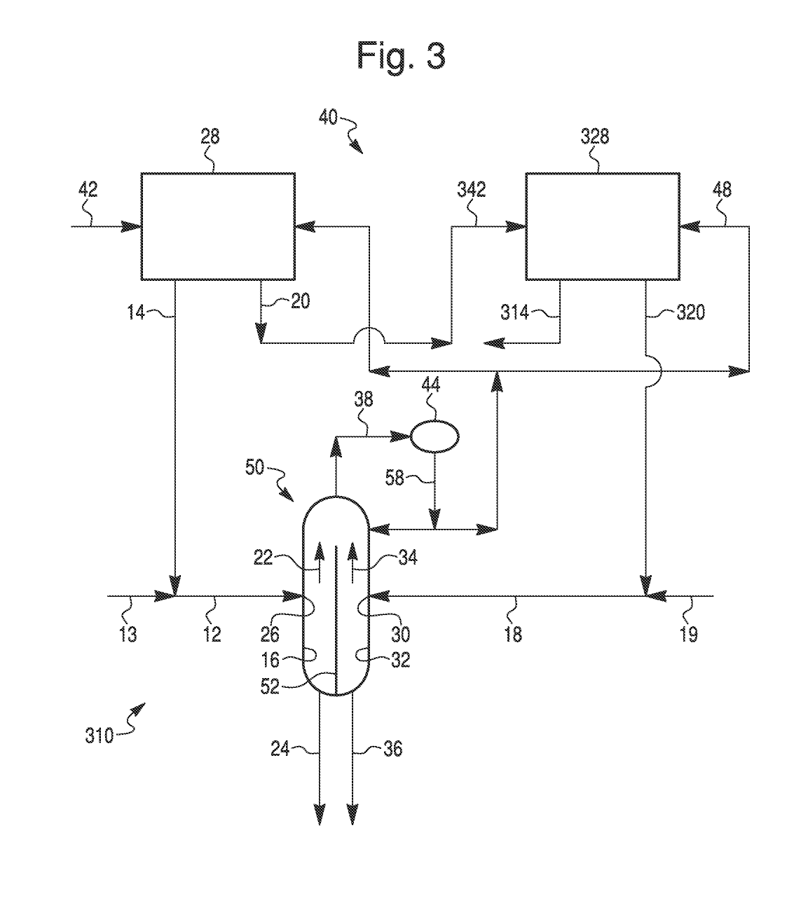

FIG. 3 is a schematic diagram of an apparatus and method for separating desorbent from an extract stream and a raffinate stream in accordance with another exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

Methods and apparatuses for separating desorbent from multiple streams are provided herein. In particular, the methods and apparatuses are provided for separating desorbent from multiple streams that each include the desorbent, where the desorbent is used to desorb components that are adsorptively separated from a mixed stream of chemical compounds (and that also include other components from which the desorbent is to be separated). Desorbents that can be separated from the multiple streams in accordance with the methods and apparatuses described herein include any desorbents that have a lower vapor pressure than substantially all of the other components that are present in the multiple streams from which the desorbent is separated. This allows the multiple streams to be fractionated with the desorbent separated in fractionation overhead streams as a result of fractionation.

The desorbent can be removed from the multiple streams while minimizing duplication of fractionation equipment by fractionating the individual streams in respective fractionation zones that are in liquid isolation from each other, but that are also in vapor communication with each other. In this manner, the fractionation overhead streams from the respective fractionation zones are combined while the fractionation bottom streams from the respective fractionation zones are kept separate, thereby at least avoiding duplication of separate overhead receivers, pumps, or other overhead-handling equipment that would otherwise be required if the fractionation overhead streams from the respective fractionation zones were to be separated. Further, a split fractionation column can be employed, with the respective fractionation zones included in the split fractionation column and separated by at least one internal partition to maintain liquid separation between the respective fractionation zones, thus avoiding duplication of separation fractionation columns for the respective fractionation zones.

In an embodiment, and as shown in FIG. 1, an apparatus 10 for separating desorbent from multiple streams is provided. In this embodiment, one of the streams from which desorbent is separated is a first stream 12 that includes an extract stream 14 from an adsorption zone 40. Another of the streams from which desorbent is separated is a second stream 18 that is different from the first stream 12 and includes a raffinate stream 20 from the adsorption zone 40. As referred to herein, the extract stream 14 includes an adsorbed component that is separated from a feed stream 42 in the adsorption zone 40, and the raffinate stream 20 includes an unadsorbed component from the feed stream 42 that is not adsorbed in and that passes through the adsorption zone 40. The first stream 12 and the second stream 18 are different at least in the respect that the first stream 12 includes the extract stream 14 and the second stream 18 includes the raffinate stream 20, with the extract stream 14 absent from the second stream 18 and the raffinate stream 20 absent from the first stream 12. The extract stream 14 and the raffinate stream 20 both include desorbent that is employed to desorb the adsorbed component from the adsorption zone 40. It is to be appreciated that the first stream 12 may include additional components other than those that originate from the extract stream 14, and the second stream 18 may likewise include additional components other than those that originate from the raffinate stream 20. For example, in an embodiment and as shown in FIG. 1, a first supplement stream 13 and a second supplement stream 19 may be mixed with the extract stream 14 and the raffinate stream 20, respectively, to form the first stream 12 and the second stream 18 from which the desorbent is separated. The first supplement stream 13 and the second supplement stream 19 may have similar chemical makeups as the extract stream 14 and the raffinate stream 20, respectively, and may benefit from separation of components therein along with the extract stream 14 and the raffinate stream 20. Furthermore, although not shown, it is to be appreciated that the multiple streams from which the desorbent is separated can also include additional streams beyond the first stream 12 and the second stream 18 in accordance with the methods and apparatuses described herein.

In an embodiment and as shown in FIG. 1, the apparatus 10 includes the adsorption zone 40, which encompasses any adsorption stage 28 or combination of adsorption stages 28 that are present within the apparatus 10 and within which adsorptive separation is conducted. In particular, the adsorption zone 40 includes one or more adsorption stages 28 for receiving one or more feed streams 42 and for selectively adsorbing a component from the one or more feed streams 42 to produce the extract stream 14 and the raffinate stream 20. Referring to FIG. 1, the adsorption zone 40 is shown including one adsorption stage 28 for receiving one feed stream 42. In this embodiment, the extract stream 14 is produced from the same adsorption stage 28 that produces the extract stream 14. However, in other embodiments as described in further detail below and referring momentarily to FIG. 3, the adsorption zone 40 includes a plurality of adsorption stages 28, 328 with the respective adsorption stages 28, 328 receiving different feed streams 42, 342 and adsorbing different components from the different feed streams 42, 342. In the exemplary embodiment of FIG. 3, the extract stream 14 is produced from a different adsorption stage 28, 328 that produces the raffinate stream 320 that is separated in accordance with the methods and apparatuses described herein. However, although not shown in the Figures, it is to be appreciated that the extract stream and the raffinate stream may be produced from the same adsorption stage even when the plurality of adsorption stages is included in the adsorption zone. In yet further embodiments that are not shown in the Figures, a single adsorption stage may be configured to receive multiple different feed streams, with a single extract stream and a single raffinate stream produced by the single adsorption stage. Configurations of adsorption stages 28 are known in the art, and techniques for conducting adsorption are also known in the art. In an embodiment, the one or more adsorption stages 28 support continuous operation, with the feed stream 42 entering the one or more adsorption stages 28 and the extract stream 14 and the raffinate stream 20 leaving the one or more adsorption stages 28 at consistent compositions over time. Adsorption stages that support continuous operation are also known in the art.

Suitable feed streams 42 that are separated in the adsorption zone 40 are not limited and may include any feed stream 42 from which components can be separated through adsorption. In an embodiment, the component that is separated from the feed stream 42 through adsorption is a hydrocarbon component, i.e., one or more compounds that include only carbon and hydrogen atoms. Examples of hydrocarbon components that may be separated from feed streams 42 through adsorption may be chosen from, but are not limited to, an aromatic component, a linear paraffin component, or an olefin component. Specific examples of aromatic hydrocarbons that may be separated from feed streams 42 through adsorption include para-xylene or meta-xylene (which may be separated from mixed C8 aromatic isomers including ortho-xylene and ethylbenzene in the feed stream 42); and para-cymene or meta-cymene (which may be separated from other cymene isomers in the feed stream 42). Linear paraffins may be separated from branched or cyclic hydrocarbons through adsorption, and olefins may be separated from paraffins through adsorption. In another embodiment, the component that is separated from the feed stream 42 through adsorption is an organic component that is different from the aforementioned hydrocarbon component. Examples of organic components that may be separated from the feed stream 42 include carbon-containing compounds that also contain one or more heteroatoms such as, but not limited to, nitrogen, oxygen, sulfur, and/or halogen, and such organic compounds may be separated from other hydrocarbons that are present in the feed stream 42. For example, para-cresol or meta-cresol may be separated from other cresol isomers in the feed stream 42. As another example, fructose may be separated from mixed sugars in the feed stream 42. In another embodiment, the component that is separated from the feed stream 42 through adsorption is an inorganic component such as, for example, a metal or metal-containing compound. Adsorption of all of the aforementioned components from feed streams 42 is known in the art, and appropriate adsorption materials for separating the aforementioned components from feed streams 42 are known to those of skill in the art.

Referring to FIG. 1, the adsorbed component is desorbed from the adsorption zone 40 with a desorbent stream 48 that includes the desorbent to produce the extract stream 14 and the raffinate stream 20. The desorbent stream 48 includes the desorbent and, in an embodiment, the desorbent stream 48 includes substantially pure desorbent, e.g., at least 90 weight % (wt %), such as at least 99 wt %, of the desorbent is present in the desorbent stream 48 based on the total weight of the desorbent stream 48. The desorbent, as referred to herein, includes any compound or combination of compounds that is effective to desorb the adsorbed component from adsorbent material and that has a lower vapor pressure than the adsorbed component, thereby enabling the desorbent in the extract stream 14 to be separated from the adsorbed component through fractionation. Such desorbents are generally known in the art as “light” desorbents. Specific desorbents that have the lower vapor pressure than the adsorbed component may vary depending upon the particular adsorbed component. In an embodiment, the desorbent includes an aromatic compound that has a lower vapor pressure than the adsorbed component. For example, when the adsorbed component is a xylene, an aromatic compound such as toluene is a useful desorbent. As another example, when the adsorbed component is a cymene, an aromatic compound such as a xylene is a useful desorbent. Non-aromatic desorbents are also suitable, depending on the adsorbed component. As one example, when the adsorbed component is a cresol, an aliphatic alcohol may be a useful desorbent. Various “light” desorbents that are effective to desorb particular adsorbed compounds can be readily identified by those skilled in the art.

As alluded to above, the extract stream 14 and the raffinate stream 20 both include the desorbent. In particular, after desorbing the adsorbed compound from the adsorption zone 40 to produce the extract stream 14 and the raffinate stream 20, the desorbent remains with the adsorbed component in the extract stream 14. The desorbent also dilutes the unadsorbed component and remains with the unadsorbed component in the raffinate stream 20. As such, the desorbent is present in both the extract stream 14 and the raffinate stream 20 that are produced by the adsorption zone 40. The first stream 12 and the second stream 18 are substantially free of compounds that have a higher vapor pressure than the desorbent, thereby enabling the desorbent to be separated from both the first stream 12 and the second stream 18 through fractionation without contaminating the separated desorbent with other compounds. It is to be appreciated that compounds that have the higher vapor pressure than the desorbent can be removed from the feed stream 42 in upstream separation units (not shown) prior to separation in the adsorption zone 40 such that the extract stream 14 and the raffinate stream 20 are substantially free of such compounds, with only trace amounts, e.g., less than about 1 weight % based on the total weight of the extract stream 14 and the raffinate stream 20, of the compounds that have higher vapor pressure than the desorbent possibly present in the extract stream 14 and the raffinate stream 20. Further, although not shown, a purge steam may be employed to separate co-boiling contaminants from the desorbent, where the co-boiling contaminants have a substantially similar vapor pressure as the desorbent, to avoid accumulation of the co-boiling contaminants in the desorbent.

Referring to FIG. 1, a first fractionation zone 16 and a second fractionation zone 32 are provided for fractionating the first stream 12 and the second stream 18, respectively. In particular, in an embodiment and as shown in FIG. 1, the first fractionation zone 16 is in fluid communication with the adsorption zone 40 for receiving the first stream 12 that includes the extract stream 14 from the adsorption zone 40, and the second fractionation zone 32 is in fluid communication with the adsorption zone 40 for receiving the second stream 18 that includes the raffinate stream 20 from the adsorption zone 40. The first stream 12 is fractionated into a first fractionation overhead stream 22 and a first fractionation bottom stream 24 in the first fractionation zone 16, and the second stream 18 is fractionated into a second fractionation overhead stream 34 and a second fractionation bottom stream 36 in the second fractionation zone 32. Because the first stream 12 includes the extract stream 14 from the adsorption zone 40 and the second stream 18 includes the raffinate stream 20 from the adsorption zone 40, there is a desire to avoid cross-contamination between the first stream 12 and the second stream 18 while separating the desorbent therefrom. Thus, the first fractionation zone 16 is provided in liquid isolation from the second fractionation zone 32, but is also in vapor communication with the second fractionation zone 32. By “liquid isolation”, it is meant that combined flow of liquid in the first fractionation zone 16 and liquid in the second fractionation zone 32 is prevented at least at a first introduction point 26 of the first stream 12 into the first fractionation zone 16 and at a second introduction point 30 of the second stream 18 into the second fractionation zone 32. The first fractionation overhead stream 22 and the second fractionation overhead stream 34 include the desorbent, while the first fractionation bottom stream 24 includes the adsorbed component from the extract stream 14 and the second fractionation bottom stream 36 includes the unadsorbed component from the raffinate stream 20. Because the first fractionation zone 16 and the second fractionation zone 32 are in vapor communication, the first fractionation overhead stream 22 and the second fractionation overhead stream 34 that are produced by the first fractionation zone 16 and the second fractionation zone 32, respectively, and that include the desorbent can be combined in a combined fractionation overhead stream 38. It is to be appreciated that minor amounts of reflux including compounds that originate from first stream 12 and/or the second stream 18 can be re-introduced into the opposing fractionation zones 16, 32 without materially affecting downstream processing as described in further detail below.

In an embodiment and as shown in FIGS. 1 and 2, the first fractionation zone 16 and the second fractionation zone 32 are provided in a split fractionation column 50. The split fractionation column 50 includes an internal partition 52 to define the first fractionation zone 16 and the second fractionation zone 32. It is to be appreciated that, although not shown, the split fractionation column 50 may include multiple internal partitions 52 to define more than two fractionation zones therein, depending upon a number of different streams that are to be fractionated to separate the desorbent therefrom. As shown in FIG. 2, the internal partition 52 partially divides the split fractionation column 50 to provide the first fractionation zone 16 in liquid isolation from the second fractionation zone 32, while also providing for vapor communication between the first fractionation zone 16 and the second fractionation zone 32 in a space within the split fractionation column 50 above the internal partition 52. Trays 54 are disposed in the first fractionation zone 16 and the second fractionation zone 32 to enable efficient fractionation and reflux. In an embodiment, the first stream 12 and the second stream 18 are introduced into the split fractionation column 50 below a top tray within the respective fractionation zones, such as at least four trays 54 below the top tray within the respective fractionation zones and below the internal partition 52, to effectively maintain liquid separation between the first fractionation zone 16 and the second fractionation zone 32 and to avoid intermingling of liquid fractions in the first fractionation zone 16 and the second fractionation zone 32. It is to be appreciated that the split fractionation column 50 may include trays 54 above the internal partition 52, and that some intermingling of liquid fractions from the first fractionation zone 16 and the second fractionation zone 32 may occur in the trays 54 that are above the internal partition 52, although substantially no cross-contamination should occur between the first fractionation zone 16 and second fractionation zone 32 of the split fractionation column 50 as described herein. However, even if the intermingled liquid fractions are included in the first fractionation bottom stream 24 or the second fractionation bottom stream 36, cross-contamination of the first fractionation bottom stream 24 and the second fractionation bottom stream 36 is minimal.

The first fractionation overhead stream 22 and the second fractionation overhead stream 34 are substantially free of compounds that have a higher vapor pressure than the desorbent, and the first fractionation overhead stream 22 and the second fractionation overhead stream 34 generally include substantially pure desorbent, e.g., at least 90 wt %, such as at least 99 wt %, of desorbent is present based on the total weight of the fractionation overhead streams 22, 34. As such, the first fractionation overhead stream 22 and the second fractionation overhead stream 34 are combined to produce the combined fractionation overhead stream 38 that includes the desorbent, and combination of the first fractionation overhead stream 22 and the second fractionation overhead stream 34 avoids duplication of equipment for separate processing of the first fractionation overhead stream 22 and the second fractionation overhead stream 34. In an embodiment and as shown in FIGS. 1 and 2, the first fractionation overhead stream 22 and the second fractionation overhead stream 34 are combined within the split fractionation column 50. However, it is to be appreciated that in other embodiments (not shown), the first fractionation overhead stream 22 and the second fractionation overhead stream 34 may be separately conveyed from the split fractionation column 50 and combined outside of the split fractionation column 50.

While the first fractionation overhead stream 22 and the second fractionation overhead stream 34 are combined, the first fractionation bottom stream 24 is maintained separate from the second fractionation bottom stream 36. Such separation is accomplished, for example, by the internal partition 52 in the split fractionation column 50. The first fractionation bottom stream 24 and the second fractionation bottom stream 36 are separately removed from the first fractionation zone 16 and the second fractionation zone 32, respectively, and may be provided to further downstream processes (not shown) for use as end products, as a reactant stream for other processes, and/or for further separation of compounds contained therein.

The combined fractionation overhead stream 38 including the desorbent can be used for any purpose for which the particular desorbent that is contained therein is generally used, for example as an end product, as a reactant stream for other processes within the apparatus 10, and/or for again desorbing the adsorbed component from the adsorption zone 40. In an embodiment and as shown in FIG. 1, the combined fractionation overhead stream 38 may be dried in a dryer 44 to produce a dried fractionation overhead stream 58, with optional reflux of a portion of the dried fractionation overhead stream 58 back into the split fractionation column 50. Further, as shown in FIG. 1, at least a portion of the desorbent from the combined fractionation overhead stream 38 and, more particularly, the dried fractionation overhead stream 58, may be included in the desorbent stream 48 that is used for desorption of the adsorbed component in the adsorption zone 40.

As described in detail above and as shown in FIG. 1, the embodiment of the method and apparatus 10 as shown in FIG. 1 involves fractionating the second stream 18 that includes the raffinate stream 20 from a same adsorption stage 28 in the adsorption zone 40 that produces the extract stream 14. In another embodiment and as shown in FIG. 3, the adsorption zone 40 includes a plurality of adsorption stages 28, 328, and different components are adsorbed from different feed streams 42 in the respective adsorption stages 28, 328. Such a configuration may be desirable when a particular feed stream 42 includes multiple components whose separation is desired through separate adsorption stages 28, 328. For example, in an embodiment, the different feed streams 42, 342 include an upstream feed stream 42 and a downstream feed stream 342. In this embodiment and as shown in FIG. 3, the plurality of adsorption stages 28, 328 includes an upstream adsorption stage 28 and a downstream adsorption stage 328. Components are adsorbed from the upstream feed stream 42 in the upstream adsorption stage 28 to produce an upstream extract stream 14 and an upstream raffinate stream 20, and the downstream feed stream 342 includes at least a portion of the upstream raffinate stream 20. Components from the downstream feed stream 342 that include at least a portion of the upstream raffinate stream 20 are then adsorbed in the downstream adsorption stage 328 to produce a downstream extract stream 314 and a downstream raffinate stream 320. The embodiment of the method and apparatus 310 shown in FIG. 3 may be useful, for example, when the upstream feed stream 42 includes xylene, such as a mixture of para-, meta-, and ortho-xylenes along with ethylbenzene. For example, the upstream adsorption stage 28 may include a para-xylene adsorption unit 28 for receiving the feed stream 42 and for adsorbing para-xylene therefrom. The para-xylene adsorption unit 28 adsorbs para-xylene to produce the upstream raffinate stream 20 that is depleted of para-xylene but that still contains meta-xylene and other C8 compounds such as ortho-xylene and ethylbenzene. Also in this embodiment and as shown in FIG. 3, the downstream adsorption stage 328 may include a meta-xylene adsorption unit 328. In this embodiment, the upstream raffinate stream 20 is included in the downstream feed stream 342 and is fed to the meta-xylene adsorption unit 328, with meta-xylene adsorbed from the downstream feed stream 342 to produce a downstream raffinate stream 320 that is depleted of meta-xylene and para-xylene. Although not shown, it is to be appreciated that, in other embodiments, the plurality of adsorption stages may include adsorption stages that operate in parallel, with completely separate feed streams provided to the respective adsorption stages.

In an embodiment, the second stream 18 includes the raffinate stream 20 from the different adsorption stage 328 than the adsorption stage 28 that produces the extract stream 14 that is included in the first stream 12. For example, as shown in FIG. 3, the extract stream 14 that is included in the first stream 12 is provided from the upstream adsorption stage 28, and the raffinate stream 20 that is included in the second stream 18 is provided from the downstream adsorption stage 328. However, it is to be appreciated that various configurations of first streams and second streams are possible so long as the first stream 12 and the second stream 18, as well as any other streams that are fractionated in the split fractionation column 50, include the same desorbent and are substantially free of compounds that have a higher vapor pressure than the desorbent. Separation of the desorbent from the first stream 12 and the second stream 18 can be conducted in the same manner as described above.

In the embodiment of the method and apparatus 310 shown in FIG. 3, the combined fractionation overhead stream 38 that includes the desorbent may be processed in the same manner as described above. The combined fractionation overhead stream 38, and more particularly the dried fractionation overhead stream 58, may be split to provide the desorbent back to the individual adsorption stages 28 of the plurality of adsorption stages 28.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of separating desorbent from multiple streams, the method comprising:
fractionating a first stream in a first fractionation zone into a first fractionation overhead stream and a first fractionation bottom stream, wherein the first stream comprises an extract stream from an adsorption zone, and wherein the first fractionation overhead stream comprises a desorbent;
fractionating a second stream different from the first stream in a second fractionation zone into a second fractionation overhead stream and a second fractionation bottom stream, wherein the second fractionation zone is in liquid isolation from and in vapor communication with the first fractionation zone, wherein the second stream comprises a raffinate stream from the adsorption zone, and wherein the second fractionation overhead stream comprises the desorbent;
separately removing the first fractionation bottom stream from the first fractionation zone and the second fractionation bottom stream from the second fractionation zone; and
combining the first fractionation overhead stream from the first fractionation zone and the second fractionation overhead stream from the second fractionation zone to produce a combined fractionation overhead stream comprising the desorbent.

2. The method of claim 1, wherein the first stream and the second stream are substantially free of compounds having a higher vapor pressure than the desorbent, and wherein combining the first fractionation overhead stream and the second fractionation overhead stream produces the combined fractionation overhead stream that is substantially free of compounds having a higher vapor pressure than the desorbent.

3. The method of claim 1, wherein the adsorption zone comprises one or more adsorption stages, and wherein the method further comprises providing the extract stream and the raffinate stream from the one or more adsorption stages in the adsorption zone.

4. The method of claim 3, wherein fractionating the second stream comprises fractionating the second stream comprising the raffinate stream from a same adsorption stage in the adsorption zone that produces the extract stream.

5. The method of claim 3, wherein the one or more adsorption stages comprise a plurality of adsorption stages, and wherein fractionating the second stream comprises fractionating the second stream comprising the raffinate stream from a different adsorption stage than an adsorption stage that produces the extract stream.

6. The method of claim 1, further comprising adsorbing a component from a feed stream in the adsorption zone.

7. The method of claim 6, wherein the component is a hydrocarbon component, and wherein adsorbing the component from the feed stream comprises adsorbing the hydrocarbon component from the feed stream.

8. The method of claim 7, wherein adsorbing the hydrocarbon component from the feed stream comprises adsorbing the hydrocarbon component chosen from an aromatic component, a linear paraffin component, or an olefin component.

9. The method of claim 6, wherein the component is an organic component, and wherein adsorbing the component from the feed stream comprises adsorbing the organic component from the feed stream.

10. The method of claim 6, wherein the component is an inorganic component, and wherein adsorbing the component from the feed stream comprises adsorbing the inorganic component from the feed stream.

11. The method of claim 6, further comprising desorbing the component from the adsorption zone with a desorbent stream comprising the desorbent.

12. The method of claim 11, wherein desorbing the component with the desorbent stream comprises desorbing the component with the desorbent stream comprising at least a portion of the desorbent from the combined fractionation overhead stream.

13. The method of claim 11, wherein the adsorption zone comprises a plurality of adsorption stages, and wherein adsorbing the component from the feed stream comprises adsorbing different components from different feed streams in the respective adsorption stages.

14. The method of claim 13, wherein the different feed streams comprise an upstream feed stream and a downstream feed stream, wherein adsorbing different components from the different feed streams comprises adsorbing components from the upstream feed stream to produce an upstream raffinate stream, wherein the downstream feed stream comprises at least a portion of the upstream raffinate stream.

15. The method of claim 14, wherein adsorbing different components from the different feed streams further comprises adsorbing components from the downstream feed stream comprising at least a portion of the upstream raffinate stream.

16. The method of claim 1, wherein the desorbent comprises an aromatic compound, and wherein combining the first fractionation overhead stream and the second fractionation overhead stream produces the combined fractionation overhead stream comprising the aromatic compound.

17. A method of separating desorbent from multiple streams, the method comprising:
providing a split fractionation column comprising an internal partition defining a first fractionation zone and a second fractionation zone in liquid isolation from and in vapor communication with the first fractionation zone;
fractionating a first stream in the first fractionation zone into a first fractionation overhead stream and a first fractionation bottom stream, wherein the first stream comprises an extract stream from an adsorption zone, and wherein the first fractionation overhead stream comprises a desorbent;
fractionating a second stream different from the first stream in the second fractionation zone into a second fractionation overhead stream and a second fractionation bottom stream, wherein the second fractionation zone is in liquid isolation from and in vapor communication with the first fractionation zone, wherein the second stream comprises a raffinate stream from the adsorption zone, and wherein the second fractionation overhead stream comprises the desorbent;
separately removing the first fractionation bottom stream from the first fractionation zone and the second fractionation bottom stream from the second fractionation zone; and
combining the first fractionation overhead stream from the first fractionation zone and the second fractionation overhead stream from the second fractionation zone to produce a combined fractionation overhead stream comprising the desorbent.

18. The method of claim 17, wherein the first fractionation zone and the second fractionation zone are in vapor communication within the split fractionation column, and wherein combining the first fractionation overhead stream and the second fractionation overhead stream comprises combining the first fractionation overhead stream and the second fractionation overhead stream within the split fractionation column.

19. The method of claim 17, further comprising:
adsorbing a component from a feed stream in the adsorption zone;
desorbing the component from the adsorption zone with a desorbent stream comprising the desorbent to produce the extract stream and the raffinate stream, wherein the extract stream comprises the adsorbed component and the desorbent and wherein the raffinate stream comprises the desorbent and an unadsorbed component from the feed stream.

20. An apparatus for separating desorbent from multiple streams, the apparatus comprising:
an adsorption zone for receiving a feed stream and for selectively adsorbing a component from the feed stream to produce an extract stream and a raffinate stream;
a split fractionation column comprising an internal partition defining a first fractionation zone and a second fractionation zone in liquid isolation from and in vapor communication with the first fractionation zone, wherein the first fractionation zone is in fluid communication with the adsorption zone for receiving a first stream comprising the extract stream from the adsorption zone, and wherein the second fractionation zone is in fluid communication with the adsorption zone for receiving a second stream comprising the raffinate stream.
